(19) United States
(12) Patent Application Publication
(10) Pub. No.: US 2012/0290253 A1
(43) Pub. Date: Nov. 15, 2012

(54) APPARATUS AND METHODS FOR HEIGHT DETERMINATION

(75) Inventors: Michael Barrett, Cardiff by the Sea, CA (US); Jangwon Lee, San Diego, CA (US); Michael Mitrani, San Diego, CA (US); Eric Milne, Solana Beach, CA (US)

(73) Assignee: QUALCOMM Incorporated, San Diego, CA (US)

(21) Appl. No.: 13/104,887

(22) Filed: May 10, 2011

(51) Int. Cl. G06F 15/00

(52) U.S. Cl. 702/150; 702/166

(57) ABSTRACT

A method for determining a height (i.e., elevation above ground level) at which a communication device having an electronic processor and a sensor is located may include obtaining a reference height of a first location, the reference height being a known height relative to ground level, the reference height having a corresponding reference pressure; obtaining, with the sensor, a pressure measurement at a second location; and calculating, with the electronic processor, a height at the second location based on the pressure measurement, the reference height, and the reference pressure. The height may also be based on temperature data, location data, motion data, and/or the like.

### BACKGROUND

1. Field of the Disclosure

This disclosure relates generally to apparatus and methods for determining height (i.e., elevation above ground level). More particularly, the disclosure relates to an apparatus and method for determining height of a mobile communication device using one or more sensors.

2. Related Art

In many applications, it is advantageous to have the ability to determine a position of a wireless device. Position location capabilities may be helpful for navigation, tracking, or in the event of an emergency. Advances in the performance of portable electronics, particularly advances in the performance of processors, have added to the demand for using position location with a variety of wireless devices.

However, the classic location determination system is primarily concerned with the determination of the x and y coordinates of a wireless device. The determination of the z coordinate (e.g., elevation above sea level) is a more technically challenging problem. The ellipsoid model used by Global Position Systems (GPS) to compute elevation is different from the geoid model used for the earth.

Satellite topology is better suited for the estimation of x and y coordinates, although having more satellites in view does improve the z estimate slightly. The z-coordinate estimate is not as accurate as the x, y estimates, and the error of the z estimate is typically greater than the x, y estimates by a factor of 2 or 3 times.

### SUMMARY OF THE DISCLOSURE

A method for determining a height at which a communication device having an electronic processor and a sensor is located may include but is not limited to (any one of combination of): (i) obtaining a reference height of a first location, the reference height being a known height relative to ground level, the reference height having a corresponding reference pressure; (ii) obtaining, with the sensor, a pressure measurement at a second location; and calculating, with the electronic processor, a height at the second location based on the pressure measurement, the reference height, and the reference pressure.

In various embodiments, the method includes obtaining, with a sensor, an associated temperature measurement at one or more of the first location and the second location. Calculating, with an electronic processor, a height comprises calculating, with an electronic processor, a height at the second location based on the pressure measurement, the temperature measurement, and at least one of the reference height and the reference pressure.

In various embodiments, the method includes obtaining associated longitude and latitude coordinates for the first location; and retrieving the reference height at the first location from a database, remote from the communication device, based on the longitude and latitude coordinates. In some embodiments, obtaining comprises obtaining, via a satellite positioning system, associated longitude and latitude coordinates for the first location. In some embodiments, obtaining comprises obtaining, via a terrestrial positioning system, associated longitude and latitude coordinates for the first location.

In various embodiments, the method includes determining a location of the communication device when at the first location; comparing the location of the communication device to a set of pre-known locations each having pre-known heights; obtaining the reference height by retrieving a pre-known height of a pre-known location that matches the location of the communication device. In some embodiments, the pre-known height is stored in a memory of the communication device as the reference height. In some embodiments, one of the pre-known locations corresponds to a location of a charging station for charging the communication device. In further embodiments, a height of the charging station is stored in a memory of the communication device as the reference height. In some embodiments, one of the pre-known locations corresponds to a location of a computing device for synchronizing with the communication device. In further embodiments, a height of the computing device is stored in a memory of the communication device as the reference height.

In various embodiments, the method includes obtaining the reference height. Obtaining the height includes determining an instantaneous velocity of the communication device; comparing the instantaneous velocity with a specified threshold; and storing, in a memory of the communication device, a ground level height as the reference height, if the instantaneous velocity is greater than the specified threshold.

In various embodiments, the method includes determining whether a pressure change between the reference height and the pressure measurement was due to a height change.

In various embodiments, the method includes revising data used to determine the reference height if a pressure change between the pressure of the reference height and the measured pressure is less than a specified threshold.

In various embodiments, the method includes revising data used to determine the height if a pressure change between the pressure of the reference height and the measured pressure is greater than a specified threshold.

In various embodiments, the method includes obtaining, via a satellite positioning system, associated longitude and latitude coordinates for one or more of the first location and the second location. Calculating, with an electronic processor, a height includes calculating, with an electronic processor, a height at the second location based on the pressure measurement, the longitude and latitude coordinates, and at least one of the reference height and the reference pressure.

In various embodiments, the method includes obtaining, via a satellite positioning system, a z coordinate estimate of the height of the second location. Calculating, with an electronic processor, a height includes calculating, with an electronic processor, a height at the second location based on the pressure measurement, the z-coordinate estimate, and at least one of the reference height and the reference pressure.

In various embodiments, the method includes obtaining, via a terrestrial positioning system, associated longitude and latitude coordinates for one or more of the first location and the second location. Calculating, with an electronic processor, a height includes calculating, with an electronic processor, a height at the second location based on the pressure measurement, the longitude and latitude coordinates, and at least one of the reference height and the reference pressure.

In various embodiments, the method includes obtaining, via a terrestrial positioning system, a z coordinate estimate of the height of the second location. Calculating, with an electronic processor, a height includes calculating, with an electronic processor, a height at the second location based on the pressure measurement, the z-coordinate estimate, and at least one of the reference height and the reference pressure.

In various embodiments, the method may include obtaining, with the sensor, the reference pressure. In various embodiments, the method may include retrieving, from a remote location, the reference pressure. In various embodiments, the first location and the second location differ in at least one of longitude, latitude, and height. In various embodiments, the height is elevation above ground level. In various embodiments, the method may include storing, in a memory, the determined height as a new reference height.

A computer program product for determining a height at which a communication device having an electronic processor and a sensor is located includes a non-transitory computer-readable medium comprising code for: obtaining a reference height of a first location, the reference height being a known height relative to ground level, the reference height having a corresponding reference pressure; obtaining, with the sensor, a pressure measurement at a second location; and calculating, with the electronic processor, a height at the second location based on the pressure measurement, the reference height, and the reference pressure.

An apparatus operable in a wireless communication system, the apparatus for determining a height at which the apparatus is located my include a sensor, a processor, and a memory. The memory includes processor executable code and/or data. The processor executable code, when executed by the processor, configures the device to: obtain a reference height of a first location, the reference height being a known height relative to ground level, the reference height having a corresponding reference pressure; obtain, with the sensor, a pressure measurement at a second location; and calculate, with the processor, a height at the second location based on the pressure measurement, the reference height, and the reference pressure.

An apparatus for determining a height at which a communication device having an electronic processor and a sensor is located includes, but is not limited to, means for obtaining a reference height of a first location, the reference height being a known height relative to ground level, the reference height having a corresponding reference pressure; means for obtaining, with the sensor, a pressure measurement at a second location; and calculating, with the electronic processor, a height at the second location based on the pressure measurement, the reference height, and the reference pressure.

A method for determining a height at which a communication device having an electronic processor and a sensor is located includes (but is not limited to) any one or combination of: (i) obtaining location data for a location of the communication device; (ii) obtaining, with the sensor, a pressure measurement at the location of the communication device; (iii) obtaining elevation data for the location of the communication device based on the location data; and (iv) calculating a height of the communication device at the location based at least on the pressure measurement and the elevation data.

In various embodiments, the method includes obtaining, from a weather database, a reference sea level pressure for the location of the communication device based on the location data. Calculating a height comprises: calculating a height of the communication device at the location based at least on the pressure measurement, the elevation data, and the reference sea level pressure. In various embodiments, the location data of the communication device comprises latitude and longitude coordinates of the communication device. In various embodiments, the communication device is configured to obtain the location data, obtain the elevation data, and calculate the height.

In various embodiments, a server remote from the communication device is configured to obtain the location data from the communication device, the pressure measurement from the communication device, obtain the elevation data, and calculate the height. In some embodiments, the method further includes storing the calculated height in a memory of the communication device.

In various embodiments, the method further includes obtaining, with a sensor, a temperature at the location of the communication device. Calculating a height comprises: calculating a height of the communication device at the location based at least on the pressure measurement, the elevation data, and the temperature.

In various embodiments, obtaining location data comprises obtaining, via a satellite positioning system, location data for a location of the communication device. In various embodiments, obtaining location data comprises obtaining, via a terrestrial positioning system, location data for a location of the communication device. In various embodiments, the method further includes storing the calculated height in a memory of the communication device.

A computer program product for determining a height at which a communication device having an electronic processor and a sensor is located, comprises a non-transitory computer-readable medium. The computer-readable medium comprising code for: (i) obtaining location data for a location of the communication device; (ii) obtaining, with the sensor, a pressure measurement at the location of the communication device; (iii) obtaining elevation data for the location of the communication device based on the location data; and (iv) calculating a height of the communication device at the location based at least on the pressure measurement and the elevation data.

An apparatus, operable in a wireless communication system, for determining a height at which the apparatus is located, includes a sensor, a processor, and a memory. The memory comprising processor executable code and/or data, the processor executable code, when executed by the processor, configures the device to: (i) obtain location data for a location of the communication device; (ii) obtain, with the sensor, a pressure measurement at the location of the communication device; (iii) obtain elevation data for the location of the communication device based on the location data; and (iv) calculate a height of the communication device at the location based at least on the pressure measurement and the elevation data.

An apparatus for determining a height at which a communication device having an electronic processor and a sensor is located includes: means for obtaining location data for a location of the communication device; means for obtaining, with the sensor, a pressure measurement at the location of the communication device; means for obtaining elevation data for the location of the communication device based on the location data; and means for calculating a height of the communication device at the location based at least on the pressure measurement and the elevation data.

Such embodiments can be highly beneficial, particularly in the context of dispatching emergency services. Based on the height, emergency personnel can estimate the approximate floor on which the device is located.

### BRIEF DESCRIPTION OF THE DRAWINGS

FIG. 1A is a simplified block diagram depicting a position location system.

FIG. 1B is a simplified block diagram depicting a height determination system.

FIG. 2 is a block diagram of a wireless device such as can be used in a height determination system.

FIG. 3 depicts various functional blocks of a height determination processor.

FIG. 4 shows various sensors for determining height.

FIG. 5 is a flowchart of processing operations of a height determination method.

FIG. 6 is a flowchart of processing operations of a height determination method.

FIG. 7 is a flowchart of processing operations of a height change determination method.

FIG. 8 is a flowchart of processing operation of a height determination method.

FIG. 9 is an illustration of an exemplary use of a height determination method.

FIG. 10 is an illustration of an exemplary use of a height determination method.

### DETAILED DESCRIPTION

The detailed description set forth below in connection with the appended drawings is intended as a description of various aspects of the present disclosure and is not intended to represent the only aspects in which the present disclosure may be practiced. Each aspect described in this disclosure is provided merely as an example or illustration of the present disclosure, and should not necessarily be construed as preferred or advantageous over other aspects. The detailed description includes specific details for providing a thorough understanding of the present disclosure. However, it will be apparent to those skilled in the art that the present disclosure may be practiced without these specific details. In some instances, well-known structures and devices are shown in block diagram form in order to avoid obscuring the concepts of the present disclosure. Acronyms and other descriptive terminology may be used merely for convenience and clarity and are not intended to limit the scope of the present disclosure.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

Various embodiments of a height determination system, apparatus, and method are discussed in the disclosure. Height typically refers to elevation above ground level (i.e., a distance from a point to the ground level). For instance, the height of building is the distance from the top of the building to the ground level. This is distinguished from altitude, which is typically defined as the elevation above mean sea level. Additionally, ground level may correspond to different elevations above sea level. For example, ground level in Boulder, Colo. may correspond to 5000 feet above sea level, whereas ground level in San Diego, Calif. may correspond to 100 feet above sea level.

Providing a height of a device, for instance along with x, y coordinates (or associated reverse geocoded address) of the device can be highly beneficial, particularly in the context of dispatching emergency services. Based on the height, emergency personnel can estimate the approximate floor on which the device is located

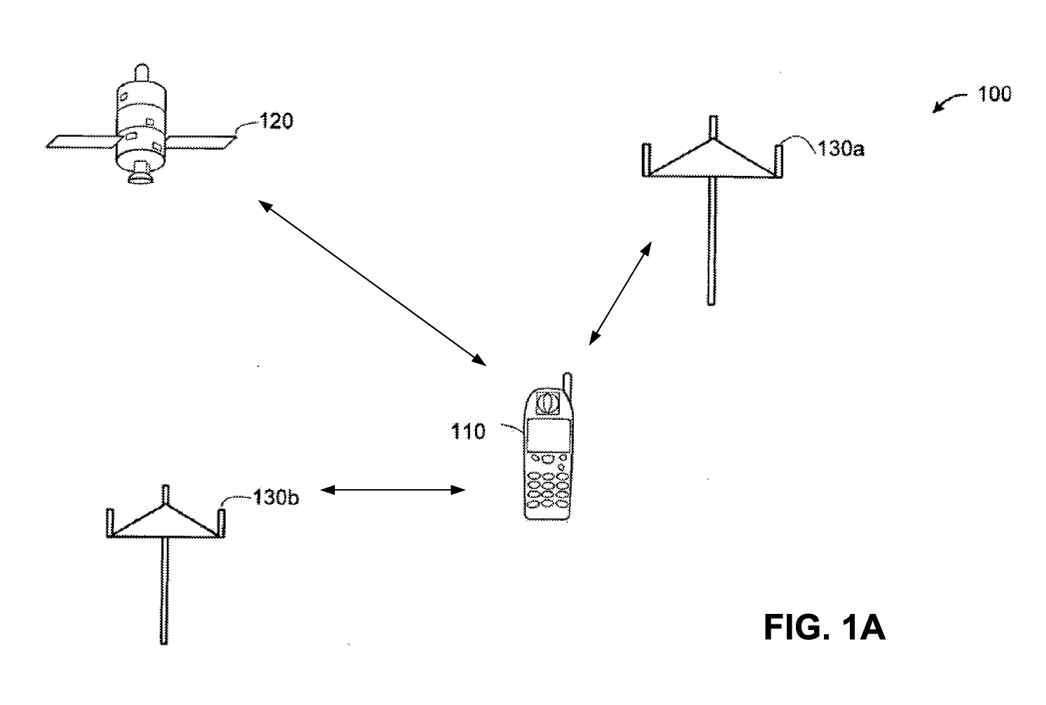

Particular embodiments are directed to a system, apparatus, and method for determining height using one or more sensors. Such embodiments can be used in a system environment such as systems 100, 150 of FIGS. 1A and 1B.

FIG. 1A is a simplified block diagram of an exemplary position location system 100. Positioning or geo-location refers to a process of determining the coordinates of an object on or near the surface of the earth. In the position location system 100, a mobile station (MS) 110 obtains a position determination with assistance from one or more satellite 120 and/or base stations 130a, 130b (collectively 130). The MS 110 can update its position using relative positioning data from one or more sensors that measure parameters, such as, but not limited to, velocity, acceleration, and/or the like.

The MS 110 is a wireless device having a position location capability. For example, the MS 110 can include a cell phone, navigation system, personal computing device, personal digital assistant, asset-tracker, tablet, portable gaming device, or other wireless communication device. The MS 110 can also exchange voice and data signals with other devices using any number or combination of communication standards (e.g., GSM, CDMA, TDNM, WCDMA, OFDM, GPRS, EV-DO, WiFi, WiMAX, S02.xx, UWB, LTE, satellite, etc). The techniques described herein can be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network can implement a radio technology such as Universal Terrestrial Radio Access (UTRA), cdma2000, etc. UTRA includes Wideband-CDMA (W-CDMA) and Low Chip Rate (LCR). CDMA2000 covers IS-2000, IS-95, and IS-856 standards. A TDMA network can implement a radio technology such as Global System for Mobile Communications (GSM). An OFDMA network can implement a radio technology such as Evolved UTRA (E-UTRA), IEEE 802.11, IEEE 802.16, IEEE 802.20, Flash-OFDM, etc. UTRA, E-UTRA, and GSM are part of Universal Mobile Telecommunication System (UMTS). Long Term Evolution (LTE) is an upcoming release of UMTS that uses E-UTRA. UTRA, E-UTRA, GSM, UMTS, and LTE are described in documents from an organization named “3rd Generation Partnership Project” (3GPP). CDMA2000 is described in documents from an organization named “3rd Generation Partnership Project 2” (3GPP2). Power for the MS 110 is supplied by a battery. In other embodiments, power can be supplied by a connection to an AC source, for example, through an AC/DC adapter.

The MS 110 determines its position location in one or more different ways. For example, as shown, the MS 110 can receive positioning signals from satellite 120 and can obtain a position location by processing information contained in the satellite positioning signals. Satellite 120 can be part of a satellite-positioning system (SPS), such as the Global Positioning System (GPS), Galileo, GLOSNASS, EGNOS, and the like. Using the known position of satellites and the timing of their respective signals, the MS 110 can determine its position location.

In addition or in the alternative to satellite-based positioning, the MS 110 can determine its position location using terrestrial (earth-based) systems or by using a combination of earth-based and satellite-based positioning. As shown, the MS 110 communicates with one or more base stations 130. The base stations 130, for example, can form range estimates using time of arrival (TOA), angle of arrival (AOA), time difference of arrival (TDOA), and/or related techniques for signals received from the MS 110. By combining their known locations with these range estimates, the base stations 130 can determine a position location for the MS 110. The base stations 130 can also assist the MS 110 by locating satellites or some or all of the performing position location processing using the data obtained by the MS 110. The MS 110 includes one or more sensors from which the MS 110 obtains positioning data. For instance, sensor data such as velocity and acceleration can be used to determine a position offset (a change from a last known position location). The position offset can be combined with a last known position location of the MS 110 in order to arrive at an updated position location.

As shown in FIG. 1B, the position location system 100 (or portions thereof) can be implemented with a height determination system 150. In various embodiments, the MS 110 has a height determination capability. In particular embodiments, the MS 110 can communicate with one or more servers 170 and/or one or more databases 180a, 180b, 180c (collectively 180) via a network 160 to determine height. The MS 110 includes one or more sensors from which the MS 110 obtains height data. For example, sensor data, such as (but not limited to) pressure, temperature, acceleration, and/or the like, can be used (alone or in various combinations) to determine a height or height offset (a change from a last known height). The height offset can be combined with a last known height of the MS 110 in order to arrive at an updated or estimate height.

In some embodiments, the database 180a is a database containing elevation data sets. In particular embodiments, the datasets are National Elevation Datasets (NED) hosted by (but not limited to) the United States Geological Survey (USGS)/Earth Resource Observation and Science (EROS). The NED is a seamless dataset with the best available raster elevation data of the conterminous United States, Alaska, Hawaii, and territorial islands. The NED serves as the elevation layer of The National Map, and provides basic elevation information for earth science studies and mapping applications in the United States. Scientists and resource managers use NED data for global change research, hydrologic modeling, resource monitoring, mapping and visualization, and many other applications. NED data, which is updated at a nominal two-month cycle, is available at varying resolutions (e.g., 1 arc-second, 1/3 arc-second, 1/9 arc-second, etc.) depending on the region. In other embodiments in which the methods are employed outside the United States, an equivalent database may be used.

In some embodiments, the database 180b is a weather service database. In particular embodiments, the weather database 180b is (but is not limited to) the National Oceanic and Atmospheric Administration. In other embodiments, the weather database 180b may be any suitable database for providing weather information, such as (but not limited to) pressure, temperature, and/or the like.

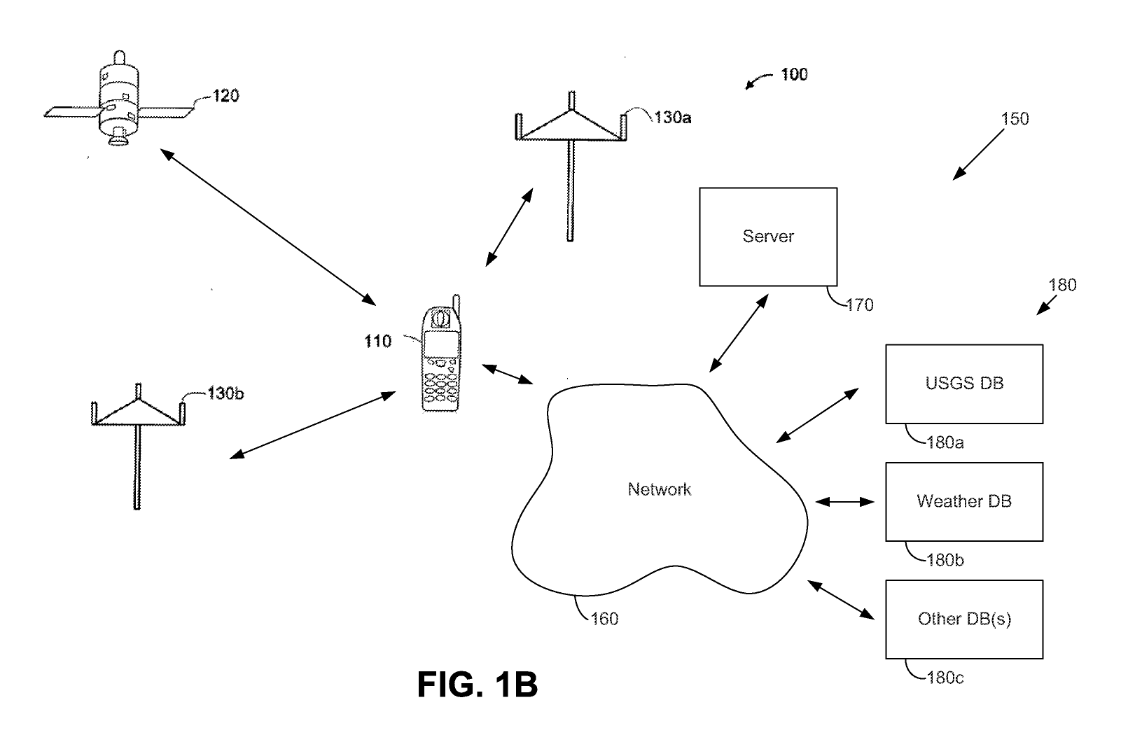

FIG. 2 is a block diagram, showing one embodiment of a wireless device 200 that can be used in the height determination system 150 (refer to FIG. 1B). In some embodiments, the wireless device 200 functions in a manner similar to that described in connection with the MS 110 (refer to FIGS. 1A and 1B). With reference to FIGS. 1A-2, in some embodiments, the wireless device 200 includes a RF transceiver 210. The RF transceiver 210 can transmit and receive positioning data as in the case of assisted GPS (A-GPS) or other networked-based positioning. In further embodiments, particularly when the wireless device 200 is a mobile phone or other mobile communicator, the RF transceiver 210 enables the wireless device 200 to exchange voice and data signals over a communication network. On a receive path, the RF transceiver 210 demodulates an incoming signal and provides data to a processor 230. On a transmit path, the RF transceiver 210 modulates data received from the processor 230 and produces an outbound signal.

A position location receiver 220 receives positioning signals and provides positioning data to the processor 230. For example, in a GPS embodiment, the position location receiver 220 can receive navigation frames from one or more GPS satellites (e.g., 120 in FIGS. 1A and 1B). The navigation frames, for example, can include time and date information, ephemeris data, parts of a satellite almanac, and/or the like. The position location receiver 220 conveys data from the positioning signals to the processor 230. Depending upon the operating mode, the position location receiver 220 can continuously track the positioning signals, or the position location receiver 220 can acquire positioning data at some interval under the control of the processor 230 and/or a controller 250.

The processor 230 receives positioning data from the position location receiver 220 and/or the RF transceiver 210. Using the positioning data, the processor 230 determines the position location of the wireless device 200 and stores the current position location in a memory 240. In connection with obtaining a position determination, the processor 230 can also determine a quality of the positioning signals and/or an amount of uncertainty in the position measurement and can store this information in the memory 240 as well. For example, among other factors, quality and uncertainty can be based upon the signal-to-noise ratio of the positioning signals, the number of satellites visible at a particular point in time, the accuracy of clock offset estimates based upon the positioning signals, the amount of time since the position location was last determined, and/or the like.

When positioning signal(s) have been detected and the wireless device 200 has acquired a position location and/or height, the processor 230 can make a determination about when and how to update the current position location and/or height with new data. In some embodiments, the wireless device 200 supports a variety of operating modes, which govern this determination. For example, if the wireless device 200 is powered by an external source, such as a car battery, the processor 230 can determine that future updates will be based upon positioning data from the position location receiver 220 and/or sensor data from one or more sensors 260 and can set a relatively short update interval. Alternatively, if the wireless device 200 is powered by an external source and the position location and/or height of the wireless device 200 has changed little over a specified interval (e.g., as might be the case when connected to a wall charger or other charging station), then the processor 230 can update the position location and/or height of the wireless device 200 based upon data from the position location receiver 220 and/or the one or more sensors 260 less frequently.

The wireless device 200 can include a battery 270. Although the connections have been omitted for clarity, the battery 270 supplies power to some or all of the components of the wireless device 200. In particular, the battery 270 can supply power to the RF transceiver 210, the position location receiver 220, the processor 230, the controller 250, and/or any other suitable component.

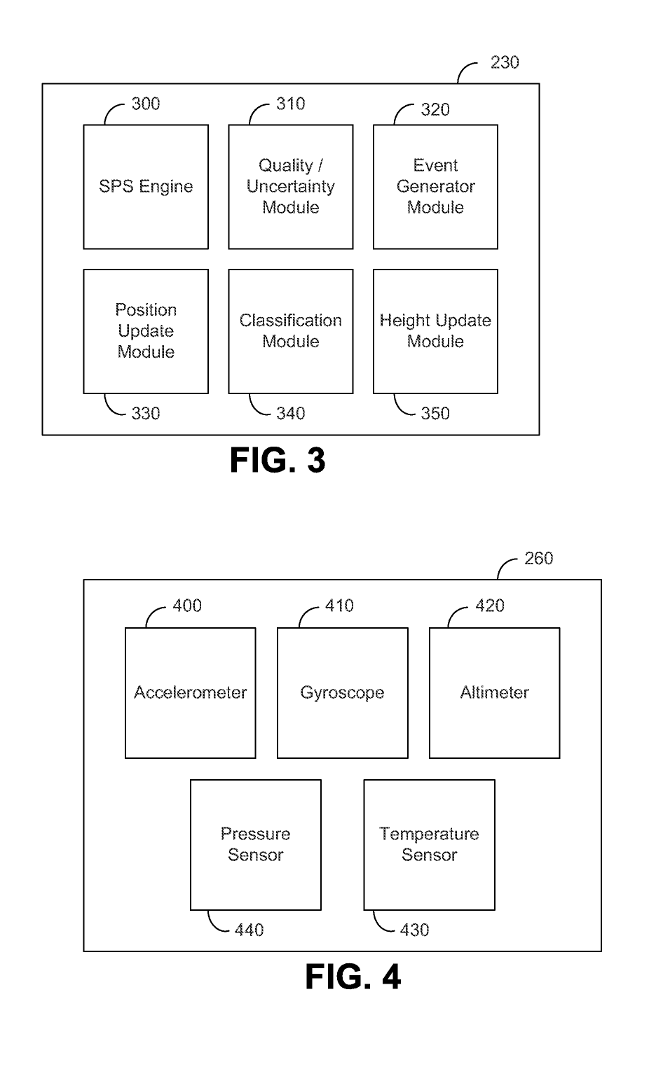

In various embodiments, processor 230 updates the position location of the wireless device 200 based upon data from the one or more sensors 260. This can occur, for instance, when a position location cannot be provided by the satellite-positioning system (and/or terrestrial-based system) due to poor satellite coverage or the like. The one or more sensors 260 provide positioning data and can be analog or digital devices. In some embodiments, the one or more sensors 260 include one or more of individual sensing elements to provide one or any combination of suitable types of information such as, but not limited to, velocity, acceleration, and/or the like, which can form the basis for updating the position location of the wireless device 200. The processor 230 receives the sensor data and processes the sensor data as may be required to produce a position offset. Thereafter, a new position location of the wireless device 200 can be determined by updating the wireless device's 200 last position location stored in the memory 240 with the position offset. Alternatively, the one or more sensors 260 can determine the position offset directly, so that the processor 230 can use the offset information with little or no additional processing. In some embodiments, the controller 250 receives the sensor data and performs the position location update. In some embodiments, the processor 230 and the controller 250 can be separate elements as shown. In other embodiments, the controller 250 (or portions of its logic) can be integrated into the processor 230. In various embodiments, the one or more sensors 260 can be used to determine height of the wireless device 200. According to various embodiments, one or more of the one or more sensors 260 is/are a barometric pressure sensor (e.g., pressure sensor 440 in FIG. 4) for measuring pressure, which can be a parameter used by the height determination system 150 to calculate a height of the wireless device 200.

The height determination system 150 can determine height based (at least partially) on pressure. For instance, one formula for determining height based on pressure (which does not account for temperature) is shown in formula (1).

Pᵢ=P₀e^{(-z/H)} (1)

Here, Pᵢ is pressure at height z. P₀ is pressure at sea level, which is approximately 1013 millibars. z is height in meters from sea level. H is a scale height, which for simplification may be approximately 7 (kilometers).

Another formula for determining altitude, a, based on pressure is shown in formula (2) in which P is a local pressure value, and rP is a reference seal level pressure value.

a=44330(1−(P/rP)^{1/5.255} (2)

To determine the difference in height, Dᵢ, between a previous pressure reading, Pᵢ₋₁, and a current pressure reading, Pᵢ, formula (3) or other suitable formula is used.

Pᵢ=Pᵢ₋₁eᵢ^{(-D}^{ᵢ}^{/H)} (3)

Thus, if the height determination system 150 has a value for pressure (estimated or detected) at time Tᵢ₋₁ for a reference point R (at height Hᵢ₋₁), then the height determination system 150 can obtain a pressure measurement Pᵢ at time Tᵢ to estimate a height Hᵢ at time Tᵢ. For simplicity, various embodiments will be discussed in relation to these simplified formulas. However, it should be noted that other pressure-to-height and height difference formulas might be used.

Accordingly, in various embodiments, the processor 230 updates the height of the wireless device 200 based upon data from the one or more sensors 260, the position location receiver 220, and/or external sources of data (e.g., databases 180). The one or more sensors 260 provide height data and can be analog or digital devices. In some embodiments, the one or more sensors 260 include any one or combination of individual sensing elements to provide information such as, pressure, velocity, acceleration, motion, temperature, and/or the like, which can form the basis for updating the height of the wireless device 200. The processor 230 receives the sensor data and processes the sensor data as may be required to produce a height offset. Thereafter, a new height of the wireless device 200 can be determined by updating the wireless device's 200 last height stored in the memory 240 with the height offset. Alternatively, the one or more sensors 260 can determine the height offset directly so that the processor 230 can use the offset information with little or no additional processing. In some embodiments, the controller 250 receives the sensor data and performs the height update.

In further embodiments, height data can be further refined (i.e., have an error estimate reduced) based upon data from the one or more sensors 260 and/or the position location receiver 220. For instance, in some embodiments, the one or more sensors 260 can include a temperature sensor (e.g., temperature sensor 430 in FIG. 4) in a case where an associated pressure-to-height formula contains a temperature factor. In some embodiments, the one or more sensors 260 can include an accelerometer or other sensors for estimating motion (such as, but not limited to, a gyroscope, magnetometer, etc.). Such sensors can be used to formulate and/or refine the height estimate.

In some embodiments, the wireless device 200 can obtain an altitude or height measurement, for instance by satellite positioning or triangulation, in a case where an associated pressure-to-height formula contains a location factor (e.g., x, y coordinates, z coordinate, associated reverse geocoded address, and/or the like). In addition or in the alternative, the wireless device can obtain altitude or height measurement through an onboard altimeter (e.g., altimeter 420 in FIG. 4) or the like. In yet other embodiments, the wireless device 200 can obtain data, directly or via the server 170 or the like, from the databases. For instance, the wireless device 200 can transmit location data (e.g., x, y coordinates of the wireless device 200) to query the USGS (United States Geological Survey) database 180a (or other suitable database) to obtain data, such as ground level data, corresponding to the location of the wireless device 200. In some embodiments, the ground level data can include additional data, such as, but not limited to, pressure, temperature, and/or the like that corresponds to the location.

In various embodiments, the height determination system 150 calibrates the wireless device 200 by obtaining a reference value associated with a known (or easily obtained) height. In example embodiments, the height determination system 150 obtains the associated pressure (e.g., via the pressure sensor of the wireless device 200) at a known height, and calibrates the wireless device 200 based on that pressure value. By determining a calibration reference value (such as a pressure value) at a known height, the height determining system 150 can determine changes in height based, at least in part on changes in a parameter (e.g., pressure) from the calibration reference value. Thus, in various embodiments, the wireless device 200 can be used both for calibrating itself (i.e., establish a reference point) and for estimating/determining height.

In other embodiments, the system 150 includes external devices (e.g., kiosks, beacons, etc.) having known heights for calibrating the wireless device 200. For instance, a user can couple (e.g., via a wireless connection, wired connection, cradle connection, or the like) the wireless device 200 to a kiosk (or the like) found in a store, building, gas station, or the like to calibrate the wireless device 200, and thus establish a reference point having a known height. For example, the reference height may be stored in a memory of the kiosk from which the reference height is retrieved by the wireless device 200, and stored in the memory 240 of the wireless device 200. As another example, the reference height may be retrieved by the kiosk (e.g., via the network 160) from a remote location (e.g., the one or more databases 180) and then provided to the wireless device 200, and stored in the memory 240 of the wireless device 200. Thus, in various embodiments, a kiosk (or the like) provides a height signal or other signal to provide a height calibration reference value to the wireless device 200. In further embodiments, the kiosk can provide other data, such as (but not limited to) location data, temperature data, pressure data, and/or the like when coupled with the wireless device 200.

According to various embodiments in which the wireless device 200 is used for calibration, calibrating (or a “calibration event”) of the wireless device 200 can occur at different opportunities, such as (but not limited to) when the wireless device 200 is charging at a charging station (at a known or verifiable height), the wireless device 200 is outside at a ground level (at a known or verifiable height (e.g., 0 m)), the device is otherwise at a known or verifiable height, and/or the like.

As discussed, the wireless device 200 can be calibrated when the wireless device 200 is on or implemented with a charging station or a separate computing device, such as a personal computer (e.g., to sync data between the wireless device 200 and the computer), which may have a known height. For instance, the charging station height can be accurately determined—for example with an accurate altimeter to take measurements at the ground level and the level of the charging station of the wireless device 200 to obtain the reference height. In other cases, the reference height can be obtained with less accuracy. For example, a device owner can register the charging station as located on the 10^{th} floor of his or her home address to obtain the reference height. The wireless device 200 can convert this information (10^{th} floor) to estimate the reference height. For instance, the reference height can be derived by multiplying the number of floors by some quantity (e.g., 15 feet per floor).

In particular embodiments, the reference height may be stored in a memory of the charging station or computing device from which the reference height is retrieved by the wireless device 200, and stored in the memory 240 of the wireless device 200. As another example, the reference height may be retrieved by the charging station or computing device from a remote location (e.g., the one or more databases 180) and then provided to the wireless device 200, and stored in the memory 240 of the wireless device 200. Thus, in some embodiments, a charging station or a separate computing device (or the like) provides a height signal or other signal to provide a height calibration reference value to the wireless device 200. In further embodiments, the computing device can provide other data, such as (but not limited to) location data, temperature data, pressure data, and/or the like, stored in the memory of the computing device when coupled with the wireless device 200. For example, when the wireless device 200 is coupled to a computer, the computer can access and retrieve remote data (e.g., temperature, pressure, location) from one of the databases 180 via the network 160. As another example, when the wireless device 200 is coupled to a computer, the computer can access and retrieve data from nearby sensors, such as (but not limited to) a temperature and/or pressure reading in the building or a temperature and/or pressure reading from a sensor outside the building.

In addition, there can be opportunities to refine the reference height over height, based on future instances of this calibration or other calibration events. For instance, where the wireless device 200 is a type that will have to be charged (or synced) relatively frequently (e.g., daily), each charging event can serve as an opportunity for one or more calibration events. Moreover, this ensures that the reference height is fairly recent (e.g., typically less than 24 hours old).

Alternatively or in addition, the wireless device 200 can be calibrated when the wireless device 200 is determined to be outside at (or near) ground level (having a height of 0). For instance, in some embodiments, the wireless device 200 can determine (or otherwise obtain) its instantaneous velocity via, for example, the one or more sensors 260 (e.g., accelerometer 400 in FIG. 4). If the horizontal velocity of the wireless device 200 is determined to be greater than a predefined threshold (e.g., 5 mph, 20 mph, etc.), then the wireless device 200 is deemed to be traveling outside, and therefore at ground level, which has a known height (e.g., 0 meters). The wireless device 200 can continue calibrating at predefined intervals of time while the horizontal velocity is determined to be greater than the threshold. While the horizontal velocity remains greater than the threshold, each reading by the wireless device 200 will serve as a new ground level reference height. When the horizontal velocity is determined to have dropped below the threshold, the wireless device 200 stops calibrating. In further embodiments, the reference height can be further defined based on the distance of the wireless device 200, for example as placed in the vehicle, from the ground level (e.g., road).

Alternatively or in addition, other methods can be implemented to determine when the wireless device 200 is outside at or near ground level including (but not limited to) when one or more of sufficient satellite coverage, pedometer data, estimated GPS elevation, and/or the like can provide confidence that the wireless device 200 is at ground level, and thus can be calibrated.

In various embodiments, the wireless device 200 is calibrated when the wireless device 200 is at a known (or verifiable) height. In particular embodiments, the system 150 calibrates the wireless device 200 based on location data (e.g., x, y location or associated reverse geocoded address) of the wireless device 200. The location data is used to query one of the databases 180 (e.g., USGS database or the like) to obtain the known ground level height (e.g., height relative to sea level) for the location corresponding to the location data.

In other embodiments, the user inputs the height of the wireless device 200 into the system 150. For instance, the height of the wireless device 200 can be accurately determined—for example with an accurate altimeter to take measurements at the ground level and the level of the wireless device 200 to obtain the reference height. In other cases, the reference height is obtainable with less accuracy. For example, the user registers or otherwise inputs that the user device is located on the 10^{th} floor of his or her home address to obtain the reference height.

In various embodiments, the wireless device 200 will have at least one reference value associated with a known (or easily obtained) height at all times. As noted, the reference point(s) can change upon calibration events. In some instances, the reference values can change between calibration events, for instance, due to changes unrelated to height changes.

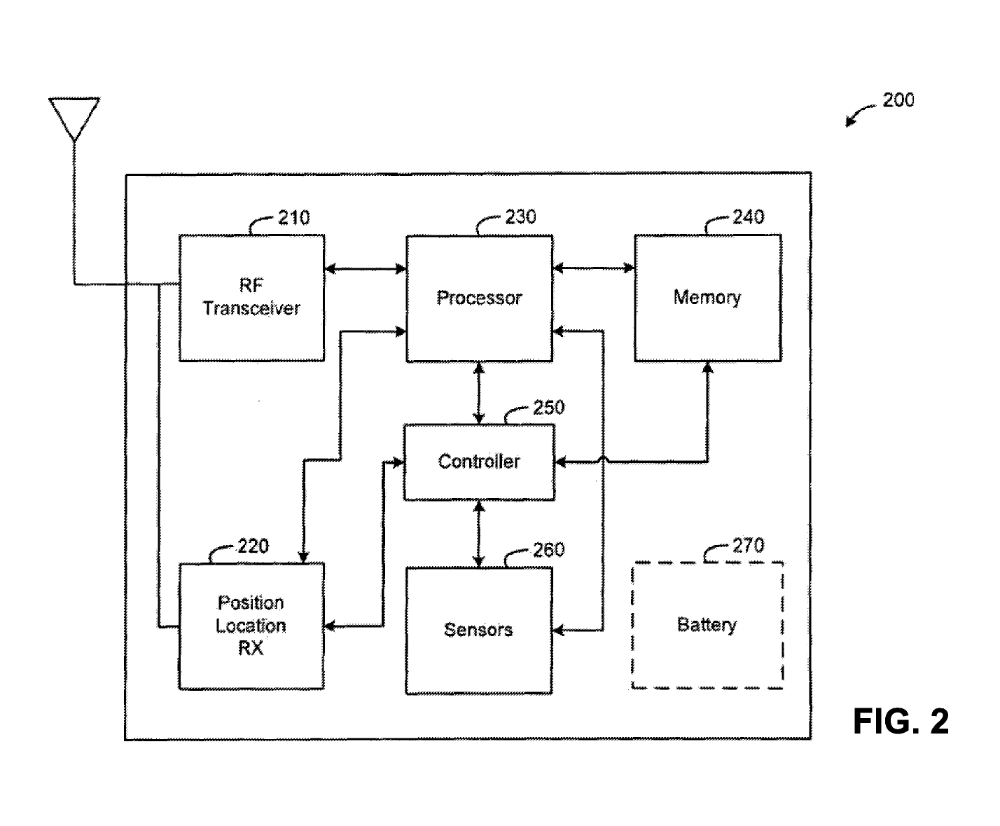

FIG. 3 depicts various functional blocks of a position/height-determination processor (e.g., processor 230 in FIG. 2) such, as can be used with the wireless device 200 (refer to FIG. 2). With reference to FIGS. 2 and 3, a satellite-positioning system (SPS) (and/or terrestrial-based system) engine 300 controls the operation of the position location receiver 220 and the process for acquiring a position location determination. In particular embodiments, this includes (but is not limited to), for example, processing A-GPS information, decoding navigation messages, synchronizing clocks, calculating a position location determination, and/or the like. In some embodiments, the processing performed by the SPS engine 300 can be activated and deactivated separately from the other elements of the processor 230. For example, the SPS engine 300 can be enabled/disabled at the direction of a controller device, such as the controller 250.

A quality/uncertainty module 310 determines information about the positioning data obtained by the SPS engine 300. This information can include a quality of the satellite-positioning (and/or terrestrial-positioning) signal and can reflect an uncertainty in the positioning based upon that signal. For example, quality can be measured at one level by the signal-to-noise ratio of the positioning signal. At another level, quality can be based upon the number of visible satellites and thus the amount of data available to establish clock and position offsets. In some embodiments, quality can be based upon an estimation algorithm that weighs a number of factors known to affect the accuracy of measurements within the particular positioning system.

The quality/uncertainty module 310 also determines information about the sensor data obtained by the one or more sensors 260. This information can include a quality of the sensor data and can reflect an uncertainty in the height based upon that sensor data. For example, quality can be based on the amount of time since the reference reading was obtained, distance from sources of external data (e.g., distance from a weather database being used to provide weather data at a given location), and/or the like. In some embodiments, quality can be based upon an estimation algorithm that weighs a number of factors known to affect the accuracy of height measurements.

An event generator 320 is a module responsible for determining calibrating events. In some embodiments, the timing of calibrating events is based upon information from the SPS engine 300, the quality/uncertainty module 310, and a classification module 340. For example, if the SPS engine 300 indicates that a positioning signal is not available, the event generator 320 does not issue a calibrating event until communication with the positioning system is possible. In this way, the processor 230 determines that sources of positioning data, positioning signals, and/or data from the one or more sensors 260 are available before generating a calibrating event.

In some embodiments, the event generator 320 determines if there is a calibration opportunity (e.g., determines the wireless device 200 is at a charging station, which has a known location and height), and if so, initiates a calibration event. Calibrating opportunities may have the same or different durations, and calibration events may be repeated as required by the height determination system 150. For example, the one or more sensors 260 may detect that an amount of motion or speed is above a predefined threshold indicating that the wireless device 200 may be traveling in a vehicle on a road, and thus at ground level. Accordingly, the sensor data allows the event generator 320 to determine that there is a calibration opportunity because the wireless device 200 is at a known height (e.g., approximately 0 meters) and initiate a calibration event to update the reference height of the wireless device 200. The event generator 320 can continue issuing calibration events as long as the amount of motion or speed is above the specified threshold.

Similarly, for example, the one or more sensors 260 can detect that an amount of motion is below the specific threshold. As a result, the event generator 320 (or other component) stops issuing calibrating events. Alternatively, for example, if a calibration event is needed or desirable (e.g., too much time has passed since the last reference reading), the event generator 320 initiates a calibration event, for example, that causes a control element (such as the controller 250) to activate a position location receiver and activate operation of the SPS engine 300 and the quality/uncertainty module 310 (and/or any other suitable module), and thus obtain location data, which can be used to obtain a reference height value (e.g., by querying one or more the databases 180 with the location data).

In various embodiments, the event generator 320 varies timing and duration of calibrating events based upon several factors. In some embodiments, the event generator 320 determines the rate and/or interval of calibration events based in part upon a threshold established by the quality/uncertainty module 310 and/or the classification module 340. For instance, the quality/uncertainty module 310 can implement an error estimation algorithm, which indicates the accuracy of the position location and/or height determined using the positioning signals and/or sensor data. The event generator 320 can use the result of this algorithm to establish, for instance, (but not limited to), the rate at which data (e.g., sensor data, positioning data, etc.) is acquired, the duration between data acquisition, or both.

For example, when sufficient data indicates that the wireless device 200 is at a known location (and thus, for instance, at a known height), the event generator 320 can increase the frequency at which positioning data is acquired from the satellite or other positioning system and/or at which data is acquired from the one or more sensors 260. That is, the event generator 320 can increase the rate of calibration events. On the other hand, when there is not sufficient data or the wireless device 200 is otherwise at an unknown location (and/or unknown height), the frequency at which positioning data and/or sensor data is acquired can be reduced, for instance, to extend battery life. That is, when there are no calibration opportunities, the event generator 320 can decrease the rate of calibration events.

The position update module 330 updates the position location of wireless device 200 based upon input from the one or more sensors 260. The height update module 350 updates the height of the wireless device 200 based upon input from the one or more sensors 260. In some embodiments, the position update module 330 and the height update module 350 can be separate elements as shown. In other embodiments, the height update module 350 (or portions of its logic) can be integrated into the position update module 330. Thus, for instance, in such embodiments, the integrated module updates both position location and height of the wireless device 200 based upon input from the one or more sensors 260.

With reference to FIGS. 2-4, the one or more sensors 260 provide data to the position update module 330 and/or the height update module 350. In various embodiments, the one or more sensors 260 include one or more microelectromechanical (MEMS) devices for determining a relative position location and/or height. The sensors 400-440 provide data for processing by the position update module 330 and/or the height update module 350. Based upon the sensor data, a relative change in the position location of wireless device 200 can be determined. Alternatively, for instance, based upon the sensor data, a change in the height of the wireless device 200 can be determined. Although shown as an array of individual sensor devices, it will be understood that one or more of the sensors can be combined or that additional sensors can be added without departing from the scope of the disclosure. As noted, the one or more sensors 260 provide individual signals representative of different types of sensor data to the processor 230. In other embodiments, the sensor data is preprocessed such that the one or more sensors 260 provide information instead of raw data to the processor 230.

An accelerometer 400 determines acceleration of the wireless device 200 over an operating interval. For instance, this can be accomplished by (but it is not limited to) measuring a change in capacitance, using piezoresistive properties, or by other methods. In some cases, the output of accelerometer 400 represents only the magnitude of the acceleration and does not represent direction. A gyroscope 410 supplies a direction of travel. Similarly, an altimeter 420 provides signals representative of a change in altitude (e.g., z-coordinate estimate). For example, the one or more sensors 260 can update their values at fixed measurement intervals. After each measurement interval, the accelerometer 400 can indicate the magnitude of the acceleration experienced during the measurement interval whereas the gyroscope 410 and the altimeter 420 can supply directional components. Thus, the position update module 330 can integrate the acceleration to determine velocity and use the directional components to form a displacement vector. The last position location of the wireless device 200 can then be updated with the displacement vector to determine a new position location. Thus, in some embodiments, the combination of the sensors 400-420 permits determining a relative change in position location in three-dimensions. In some embodiments, the wireless device 200 includes other sensors, such a magnetometer (not shown), in addition to or in place of the one or more sensors 400-420.

In some embodiments, the position update module 330 receives data from the one or more sensors 260 and determines a position offset for updating the position, for example, when there insufficient satellite coverage. In the embodiment shown, for example, the position update module 330 can include an integration function for converting data from the accelerometer 400 into a velocity vector using additional information from the gyroscope 410 and the altimeter 420. Once the sensor data has been converted, the position update module 330 combines the position offset with the last position location of wireless device 200 to determine an updated position location. The position update module 330 can repeatedly perform (but is not limited to) each or all of the following: receive sensor data, determine a position offset, and adjust the last position location of the wireless device 200 during the calibrating and estimating events. In some embodiments, the position update module 330 updates at the same rate as the SPS position location updates. In other embodiments, the rate of updates is matched to the properties of the one or more sensors 260. In still other embodiments, the rate of updates is determined according to a desired accuracy of the interim positioning. For instance, the sensor data for the position update module 330 can also (or instead) be used with other sensor data, such as from pressure sensor 440, temperature sensor 430, and/or the like, by the height update module 350 to update height.

The classification module 340 classifies changes in pressure measurements (e.g., of the reference height) as being due to a change in height or some other change. In general, the rate of change in pressure measurements due to non-height-related changes is lower than the rate of change due to height-related changes. Accordingly, the system 150 can track these changes and the height update module 350 can recalibrate the height (e.g., for non-height-related changes) or otherwise update the reference heights (e.g., for height-related changes) as determined by the classification module 340.

In particular embodiments, the classification module 340 determines whether a change in pressure (or pressure measurement) is due to a height-related change or a non-height-related change (e.g., due to temperature) based on certain classification criteria. For instance, the system 150 (e.g., the classification module 340) can implement motion analysis as part of the classification criteria. For example, a motion that is classified as walking up or down stairs would cause the associated pressure-related data to be classified as a height-related change. Similarly, a motion that is classified as elevator travel would also be classified as a height-related change. If there is little motion (e.g., below some threshold amount of motion or other filter criterion to classify significant motion), then the associated pressure-related data would be classified as a non-height-related change. In various embodiments, motion analysis is implemented with one or more sensors (e.g., accelerometers 400, gyroscopes 410, magnetometers, and/or the like). In particular embodiments, the pressure sensor 440 can implemented as part of or with the one or more sensors.

In some embodiments, “sparsity”-based classification methods may be used. That is, the classification module 340 can classify certain events based on recognition of patterns of pressure changes. For instance, as an elevator rises in height, the pressure would correspondingly change at a certain rate or pattern. Other examples of recognizable motion pattern may include (but is not limited to) patterns for climbing stairs, riding in an automobile, train, and/or the like. The classification module 340 can use this certain rate or pattern to determine that a height-related change (or non-height-related change) is occurring. This determination can be used to update the height and/or the reference height value.

The recognizable motion patterns may be stored in the memory 240 of the wireless device 200 and compared with motion data collected by the one or more sensors 260. Based on the comparison, the processor 230 (via the classification module) can determine that the wireless device 200 is experienced a recognized pattern of motion—e.g., that the wireless device 200 is being carried by a user who is climbing a set of stairs. In some embodiments, the recognizable motion patterns are stored in the memory 240 of the wireless device 200 prior to the user purchasing the device. In some embodiments, the recognizable patterns are downloaded or otherwise retrieved by the wireless device 200 to update the recognition capability of the wireless device 200. In some embodiments, the wireless device 200 stores patterns from previous instances. For example, if a certain pattern of motion is consistently determined to be a height-related change (e.g., as determined by other data), the certain pattern can be record or otherwise stored as being a height-related change. Accordingly, a future pattern of motion that substantially matches the certain pattern can be determined to be a height-related change.

Thus, in various embodiments, once a reference height is known and recalibrated based on non-height-related changes, a new height can be estimated, for example using formulas (1)-(3), formulas (4) and (4′) (discussed later), or other suitable formula (s). Alternatively, the new height can be estimated by compensating for any non-height-related changes.

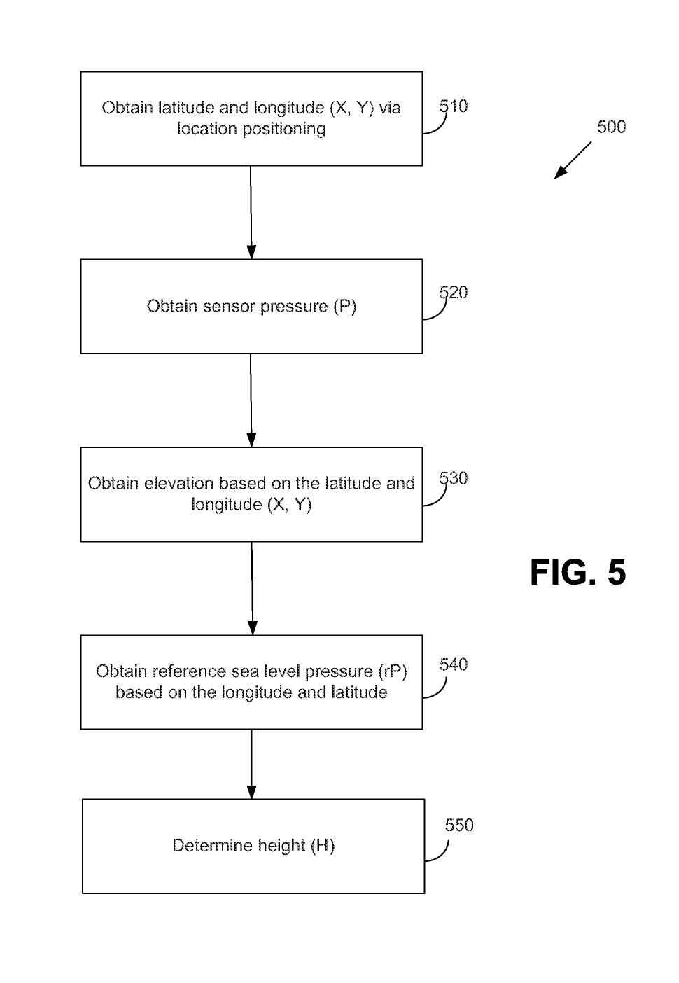

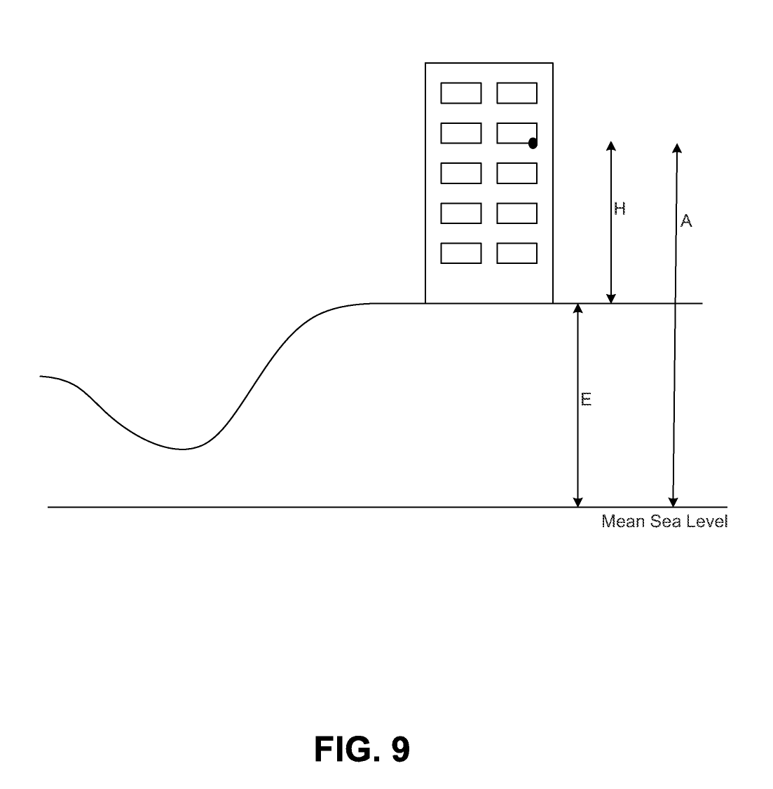

FIG. 5 is a flowchart of processing operations 500 performed according to various embodiments of a height determination method. The method can be performed by a wireless device such as the MS 110 (refer to FIGS. 1A and 1B) or wireless device 200 (refer to FIG. 2). FIG. 9 is an illustration of an exemplary use of a height determination method, such as the processing operations 500.

With references FIGS. 1A-5 and 9, at block 510, the wireless device 200 obtains a latitude and longitude (x, y coordinates), or other suitable positioning data, of the wireless device 200. Next, at block 520, the wireless device 200 measures pressure (P), for example, with the pressure sensor 450.

At block 530, the wireless device 200 provides the positioning data (e.g., x, y coordinates) to the USGS database 180a, for example, via the network 160. Accordingly, the wireless device 200 receives elevation (E) data corresponding to the positioning data from the USGS database 180a.

At block 540, the wireless device 200 provides the positioning data (e.g., x, y coordinates) to the weather database 180b, for example, via the network 160. Accordingly, the wireless device 200 receives a reference sea level pressure (rP) corresponding to the positioning data. In particular embodiments, the weather database 180b queries weather stations located near the wireless device 200 (based on the positioning data) to obtain the reference sea level pressure (and/or other weather data), and then transmit the obtained data to the wireless device 200. In other embodiments, the wireless device 200 obtains the reference sea level pressure (and/or other weather data) directly from the weather stations, for instance, via the network 160.

Then at block 550, the wireless device 200 determines height (H). In particular embodiments, the wireless device 200 determines height, for example (but not limited to) formula (2), formula (3), or any other suitable formula, by first determining altitude (A) based on the pressure (P) and the reference sea level pressure (rP), and then calculating height based on the elevation and the altitude. For instance, the height (H) is the difference between altitude (A) and elevation (E). In other embodiments, the wireless device 200 determines height based on the obtained data as discussed in (but not limited to) the disclosure (e.g., temperature, z-coordinate estimates, etc.).

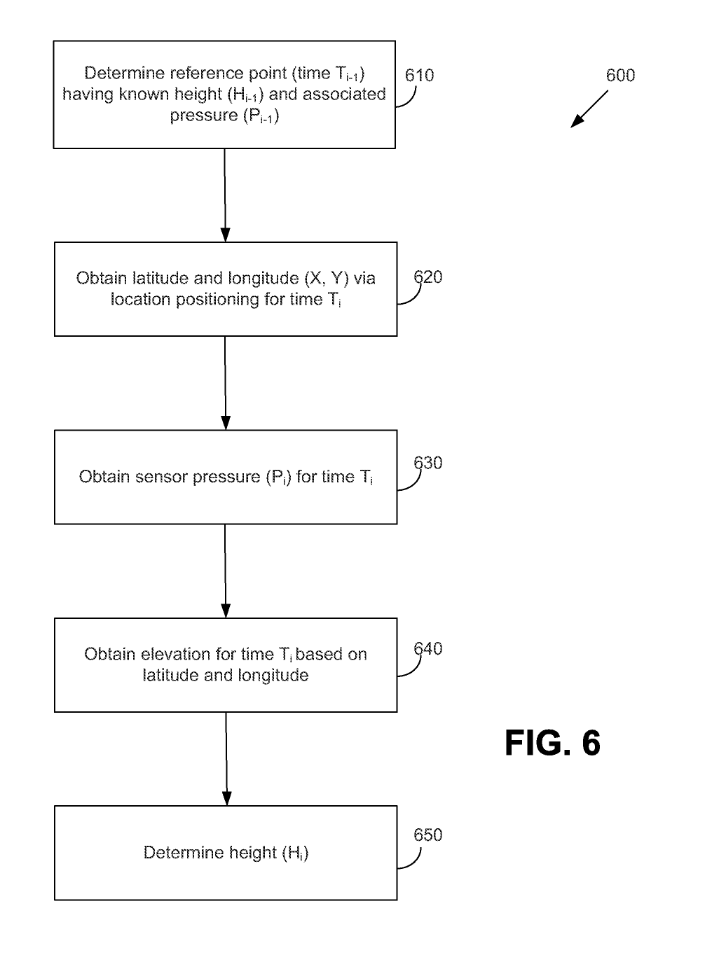

FIG. 6 is a flowchart of processing operations 600 performed according to various embodiments of a height determination method. The method can be performed by a wireless device such as the MS 110 (refer to FIGS. 1A and 1B) or wireless device 200 (refer to FIG. 2).

With references FIGS. 1A-6, the wireless device 200 obtains a reference location (e.g., at a location corresponding to time Tᵢ₋₁) having a known height. The reference point may include associated pressure. For example, this can occur during a calibration event, such as when the wireless device 200 is at a known location having a known height. As another example, the reference data may be previously determined/obtained data. For instance, the determined height at block 550 (FIG. 5), obtained pressure at block 520, and/or the like may serve as reference data.

At block 620, the wireless device 200 obtains a latitude and longitude (x, y coordinates), or other suitable positioning data, of the wireless device 200 at a location corresponding to time Tᵢ. Next, at block 630, the wireless device 200 measures pressure (P) at the location corresponding to time Tᵢ, for example, with the pressure sensor 450.

At block 640, the wireless device 200 provides the positioning data (e.g., x, y coordinates) to the USGS database 180a, for example, via the network 160. Accordingly, the wireless device 200 receives elevation data corresponding to the positioning data from the USGS database 180a.

Then at block 650, the wireless device 200 determines height. In particular embodiments, the wireless device 200 determines height by first determining a height difference (Dᵢ) between the location at time Tᵢ and the height at the reference location at time Tᵢ₋₁, and then calculating height based on the elevation and the height difference. For instance, the height is the difference between the altitude and the height difference. In other embodiments, the wireless device 200 determines height based on the obtained data as discussed in (but not limited to) the disclosure.

In some embodiments, position data (e.g., latitude and longitude) need not be obtained, and thus blocks 610 and/or 640 may be omitted Such embodiments, for instance, may be useful when satellite positioning and/or terrestrial positioning is not possible, accurate, or otherwise desired.

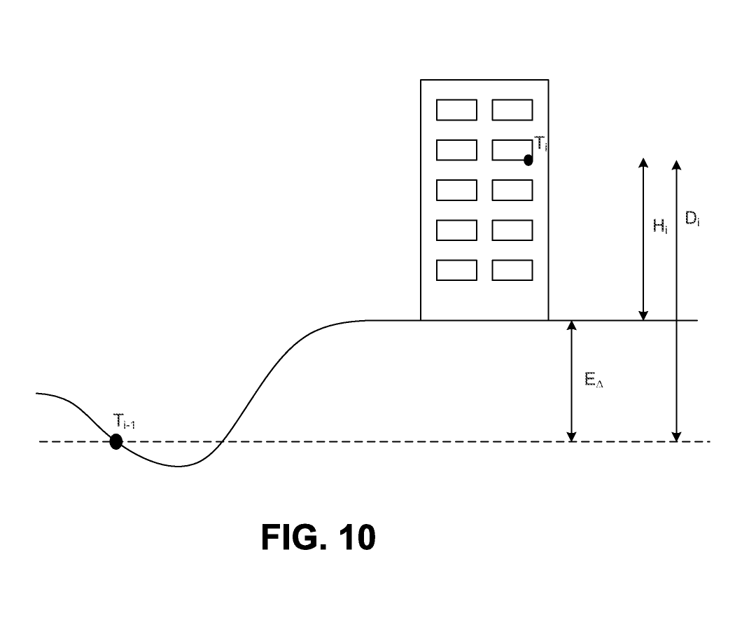

With reference to FIG. 10, a height Hᵢ of a wireless device 200 (refer to FIG. 2) at time Tᵢ can be determined based on (but not limited to) the methods discussed in the disclosure. For instance, the height Hi may be determined based on (but not limited to) formula (4).

Hᵢ=Dᵢ−(Eᵢ−Eᵢ₋₁)+Hᵢ₋₁ (4)

At a previous time Tᵢ₋₁, the wireless device 200 had a previous height Hᵢ₋₁ (having an associated pressure Pᵢ₋₁), which in the example shown in FIG. 10 is equal to ground level (e.g., 0 meters). In particular embodiments, an elevation Eᵢ at time Tᵢ may be obtained (e.g., block 640 in FIG. 6). at the previous time Tᵢ₋₁, an elevation Eᵢ₋₁ of the wireless device 200 may have been obtained at the previous time Tᵢ₋₁, for example (but not limited to) in a similar manner as the elevation Eᵢ. The elevation Eᵢ at time Tᵢ and the elevation Eᵢ₋₁ at time Tᵢ₋₁ have an elevation difference E_{Δ}.

A height difference Dᵢ is a difference between the height Hᵢ and the previous height Hᵢ₋₁. The height difference Dᵢ may be determined for example (but not limited to) formula (3). According to various embodiments, the wireless device 200 measures (e.g., with the pressure sensor) pressure Pᵢ. Then by using the measured pressure Pᵢ and the pressure Pᵢ₋₁ at time Tᵢ₋₁ in formula (3) (or other suitable formula), the height difference Dᵢ can be determined. From the above, by using (but not limited to) formula (4), the height Hᵢ is obtained.

In some embodiments, height Hᵢ may be determined without elevation data (e.g., omitting block 640 in FIG. 6) and/or position data (e.g., block 610 in FIG. 6). In such embodiments, the height may be determined, for example, based on (but not limited to) formula (4′).

Hᵢ=Dᵢ+Hᵢ₋₁ (4′)

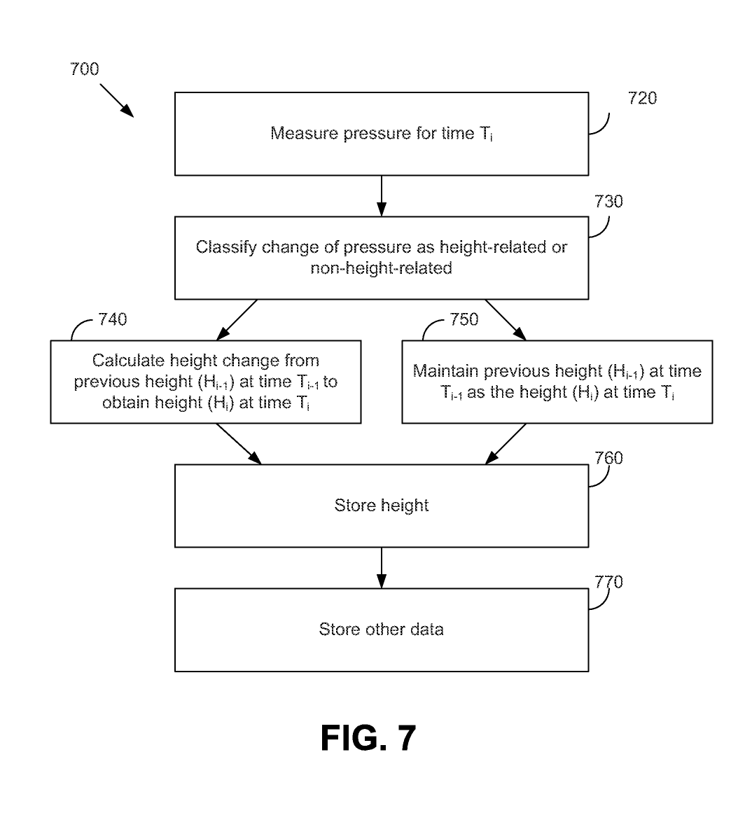

FIG. 7 is a flowchart of processing operations 700 performed according to various embodiments of a height change determination method. The method can be performed by a wireless device such as the MS 110 (refer to FIGS. 1A and 1B) or wireless device 200 (refer to FIG. 2). In particular embodiments, the processing operations 700 may be performed after the processing operations 600 (refer to FIG. 6).

At block 720, which can be performed after previous pressure measurements and/or height determinations (e.g., at time Tᵢ₋₁) to determine whether a change in height has occurred since those measurements/determinations, a pressure is measured, for example, by the pressure sensor 450 at time Tᵢ. In some embodiments, block 720 may correspond to block 520 (FIG. 5) or block 630 (FIG. 6).

Then in block 730, a change (or rate of change) in the pressure measured at time Tᵢ and the pressure measured at time Tᵢ₋₁ is classified as either a height-related change or a non-height-related change. The rate of change in pressure measurements due to non-height-related changes is typically lower than the rate of change due to height-related changes. In other embodiments, certain filtering criteria can be applied to classify the change as a height-related change or a non-height-related change.

At block 740, which corresponds to a determination that the change in the pressure measurements was because of an actual change in height, the change in height from the previous height (e.g., at time Tᵢ₋₁) is calculated to obtain the current height (at time Tᵢ). For instance, the height change is added to the previous height to obtain the current height. The height change can be calculated, for example (but not limited to) formula (3). The processing then continues to block 760.

At block 750, which corresponds to a determination that the change in the pressure measurements was non-height related (e.g., the change in pressure measurements was mainly due to a temperature change), a previous height measurement at time Tᵢ₋₁ (e.g., as determined at blocks 610, 650, 740, and/or the like of FIGS. 6 and 7) is maintained as the current height measurement at time Tᵢ. That is, the current height measurement at time Tᵢ is made to be the same as the previous height measurement at time Tᵢ₋₁. The processing then continues to block 760.

At block 760, the current height (e.g., as obtained at block 740, as maintained at block 750, and/or the like) is stored (e.g., in the memory 240 of the wireless device 200 or a memory of the remote server 170 or other remote server). In some instances, this current height (e.g., at time Tᵢ) serves as a reference height for a height determination at a later time (e.g., at time Tᵢ₊₁). At block 770, other data is stored (e.g., in the memory 240 of the wireless device 200 or a memory of the remote server 170 or other remote server), such as (but not limited to) GPS data, time, and/or the like. Blocks 720-760 (and optionally block 770) are repeated as necessary. In particular embodiments, blocks 720-760 are repeated as necessary, always using the most recent reference height determined.

With reference to FIGS. 1-7, in various embodiments, other data is obtained in addition to pressure (e.g., blocks 520, 630, 720). This other data can be used to determine a more accurate height estimate (as compared to not using the other data), to serve as filtering criteria to classify a change in pressure measurements, to retrieve data used for determining height, and/or the like. In some embodiments, this other data includes temperature data. For example, temperature be obtained by the temperature sensor 430 can be used in a pressure-to-height formula that accounts for temperature. Thus, a change in height can be more accurately estimated, particularly when there is also a temperature change. As another example, the temperature obtained by the temperature sensor 430 can be used to determine that a change in pressure measurements was not due to a change in height, but instead a change in temperature.

In other embodiments, the temperature data (and/or any other suitable data) is provided to the wireless device 200 from a remote location. For example, the wireless device 200 may provide the location (e.g., x, y coordinates) of the wireless device 200 to one or more databases (e.g., weather database 180b) to retrieve the temperature associated with the location or suitably close location. Thus, in such embodiments, the temperature sensor may be omitted or not implemented.

In some embodiments, the weather database 180b (or other database 180c) also provides pressure at that location or suitably close location. Thus, in such embodiments, the pressure sensor may be omitted or not implemented.

In some embodiments, this other data (in addition to or in alternative of temperature data) includes location data. For example, as discussed, a satellite-positioning system (e.g., GPS) and/or terrestrial-positioning system may be used to provide the wireless device 200 associated x, y coordinates or the like when a pressure-to-height formula that accounts for location is being used to determine height. As another example, the satellite-positioning system and/or terrestrial-positioning system may be used to provide the wireless device 200 a z-coordinate estimate in some embodiments.

In other embodiments, the wireless device 200 may provide location data (e.g., x, y coordinates) of the wireless device 200 to one or more databases (e.g., USGS database 180a) to retrieve the reference height value associated with the location data. In some embodiments, the other data (in addition to or in alternative of temperature data and/or location data) includes motion data, for example, as obtained from an accelerometer and/or other suitable motion sensor (e.g., accelerometer 400, gyroscope 410, magnetometer, and/or the like) or the like.

In some embodiments, some of the data used to determine height (e.g., elevation data, reference sea level pressure, etc.) is received by the wireless device 200 so that the wireless device 200 can determine height based on the received data. In other embodiments, some or all of such data is received by a remote server (e.g., 170) so that the server can determine height based on the received data. In turn, the server may transmit the determined height to the wireless device 200 or otherwise make the determined height accessible by remote devices.

In some embodiments, the wireless device 200 provides data (e.g., pressure, location data, determined height, and/or the like) to the server 170 via the network 160. The server 170 may obtain the elevation data, reference pressure data, and/or the like based on the provided data from the wireless device 200. In turn, the server 170 may determine the height based on the obtained data and the provided data from the wireless device 200.

Because pressure changes over time at the reference point (e.g., at time Tᵢ₋₁), the accuracy of a new height estimate (e.g., at time Tᵢ) will decrease over time. As such, in various embodiments, calibration events and/or pressure measurements (and/or other data, such as location data) are obtained as desired to maintain or improve the accuracy of the height estimates. For instance, calibrating events and/or pressure measurements (and/or other data) may be taken, for example, every second, every minute, every hour, or at any other desired interval. Accordingly, in various embodiments, the interval at which calibration events and/or pressure measurements (and/or other data) are taken can balance the freshness (and thus accuracy) of the pressure measurement, and resulting height estimate, with power consumption by the wireless device 200.

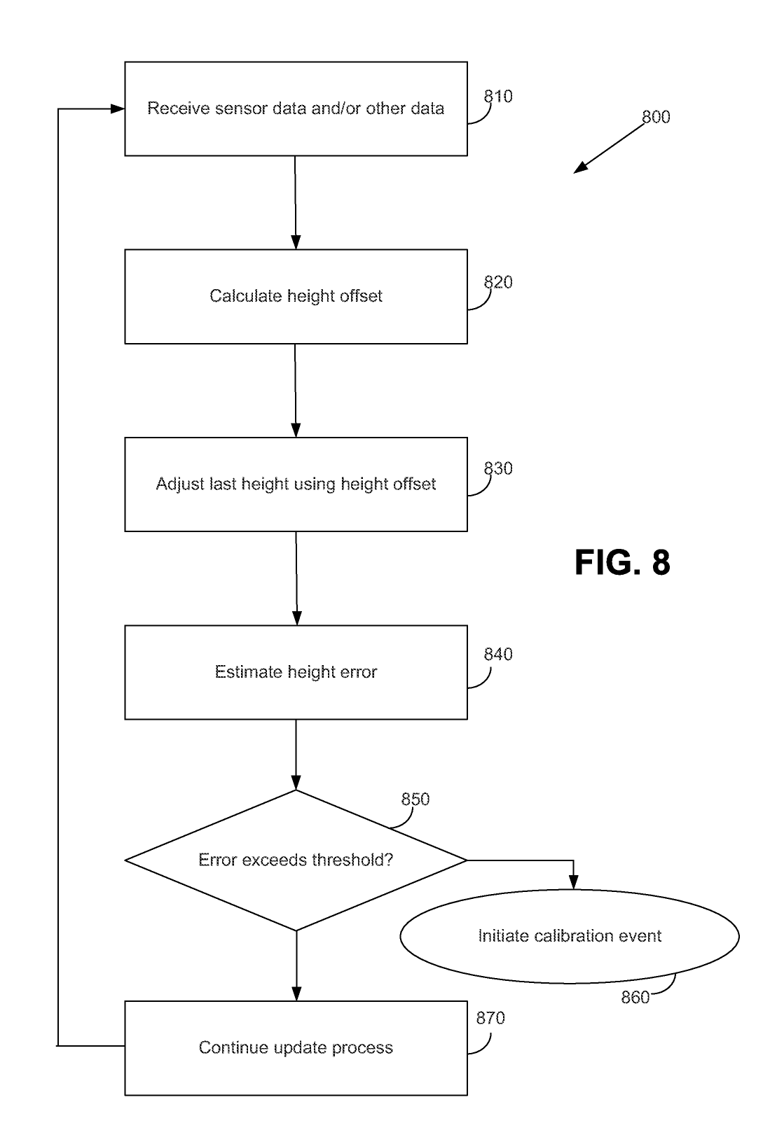

Although calibration events are performed at least once in a particular interval (e.g., once per hour), there may be instances in which the system 150 is unable to calibrate the wireless device 200 for longer than the particular interval (e.g., the wireless device 200 is in an underground structure for several hours). FIG. 8 is a flowchart of height processing 800 performed by a wireless device such as the MS 110 (refer to FIG. 1A or 1B) or the wireless device 200 (refer to FIG. 2) to estimate or measure height in such instances. Alternatively, the processing 800 can be performed in other instances (but not limited to), for example, to conserve battery power or any other instance in which less frequent updating is desirable, or when satellite positioning (and/or terrestrial positioning) is unavailable.

With reference to FIGS. 1-8, at block 810, sensor data is received for processing. In various embodiments, the sensor data provides information about the relative change in height (and/or position location) of the wireless device 210 during a particular interval of time. The sensor data can be received from one or more predetermined sensors (e.g., sensors 260) or data may be received from an arbitrary number of sensors with different capabilities as, for example, can be conveyed through a protocol for exchanging sensor data with a position location processor.

Next, at block 820, a height offset is calculated based upon the sensor data (e.g., pressure) received. Thus, sensor data is used to produce an offset, which reflects the relative change in height of the wireless device 200 since the measurement at the last known height. At block 830, the last height of the wireless device 200 is adjusted using the offset calculated at block 820 to produce an updated height. In various embodiments, blocks 810-830 correspond to one or more of blocks 720-750 (refer to FIG. 7).

In various embodiments, at block 840, a cumulative height error is tracked during the processing operations 700. In some embodiments, an error estimate is updated each time the height of the wireless device 200 is adjusted (e.g., blocks 610-650) based upon sensor data or other data. For example, initially, the error estimate can be based upon presence of or absence of and/or quality (i.e., reliability) of data used to determine height (and/or position location), such as the location data (e.g., block 620), sensor pressure data (e.g., block 630) and/or other obtained pressure data, elevation data (e.g., block 640), temperature and/or weather data, and/or the like. Generally, the presence of (and use thereof) of more of these data factors may result in a lower error estimate. Likewise, the higher the quality or reliability (e.g., additional satellite coverage may increase the certainty of the location of the wireless device 200) of the data, the lower the estimate.

Conversely, the absence of (and omission thereof) of such data factors may result in a higher error estimate. Likewise, the lower the quality or reliability (e.g., poor satellite coverage in a parking garage may reduce certainty of the location of the wireless device 200) of the data, the higher the estimate. Subsequently, the error estimate can be revised based upon similar data factors, as well as others, such as time. That is, for instance, the error estimate can be revised such that the error estimate increases with time and each height update (e.g., blocks 610-650) reflects the cumulative positioning error. For example, because pressure changes over time, as time between time Tᵢ and Tᵢ₋₁ increases, the accuracy of the height Hᵢ at time Tᵢ based (at least on) the pressure Pᵢ₋₁ decreases.

At block 850, a decision is made as to whether the error estimate exceeds a predetermined threshold. Among other things, the threshold value can be set based upon a particular application, such as navigation, or to comply with emergency services requirements. Different applications can require different degrees of height accuracy, which can, in turn, be reflected in their corresponding error thresholds. For example, a height error of no more than 30 meters may be needed for navigation purposes, whereas accuracy to within 75 meters suffices for emergency location purposes. Alternatively, a user can set the level of height accuracy desired by trading off accuracy in the form of less frequent updates, for instance, for prolonged battery life.

Processing proceeds from decision block 850 to terminal block 860 the error threshold is determined to have been exceeded. At block 860, a calibrating event is initiated (if possible) and a new reference point having a known height can be obtained. If the error threshold is not exceeded, the update process continues at block 870. As shown, new sensor data is obtained and the method repeats from block 810.

Thus, according to various embodiments, a frequency of calibration events may be reduced. For instance, a calibration event may be initiated only when needed (e.g., when the height error exceeds a defined threshold). In particular embodiments, reducing the frequency of calibrating events (e.g., from every 1 hour to every 2 hours) may occur on the occurrence of certain events, for example, when battery levels are below a certain specified level, or upon occurrence of any event where reducing the frequency of calibrating events would be desirable. That is, a rate at which calibrating events occur is at a first rate, and then upon occurrence of an event, the rate changes to a second (different) interval In other embodiments, calibrations events are performed manually, for example, when initiated by the user of the wireless device 200, initiated remotely (e.g., initiated at the server 170 to cause the wireless device 200 to perform a calibration event), and/or at specified times or intervals (e.g., on the hour each day). Reducing the number of calibrating events, for instance, may provide benefits such as (but not limited to) reduced power consumption, improved battery life, as well as other efficiencies. Other efficiencies may include, but are not limited to, reduced bandwidth and data usage (e.g., less frequent requesting of and/or transmission of data), improved data storage (e.g., with fewer calibrating events, the amount of data stored in the wireless device 200 and/or the server 170 is reduced accordingly), and/or the like.

In yet other embodiments, calibrations events are performed as frequently as desired. For instance, for navigation use, calibration events may be performed more frequently than for other uses because greater accuracy is needed for navigation. In particular embodiments, increasing the frequency of calibrating events (e.g., from every 1 hour to every 15 minutes) may occur on the occurrence of certain events, for example, when the wireless device 200 is plugged into an AC source, the wireless device 200 is being used for a purpose where greater accuracy is preferred (e.g., navigation), satellite coverage exceeds a certain specific level, and/or the like. That is, a rate at which calibrating events occur is at a first rate, and then upon occurrence of an event, the rate changes to a second (different) interval

With reference to FIGS. 1-8, according to various embodiments, the latitude and longitude location are obtained using (but not limited to) GPS, triangulation, or the like. Then, the wireless device 200 obtains the ground elevation by querying the USGS database 180a or the like (directly or via one or more intermediate servers, such as server 170) based on the obtained latitude and longitude location. The ground elevation may be used to determine height, for instance, as discussed with respect to processing operations 500, 600 (refer to FIGS. 5 and 6). In particular embodiments, this known ground elevation then serves as the new reference height. If pressure information for the new reference height is available, the height difference is determined based (at least partially) on the measured pressure along with the new reference height (which approximately equals the ground elevation and the associated pressure).

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. Such hardware, software, firmware, or any combination thereof may part of or implemented with any one or combination of the MS 110 (refer to FIGS. 1A and 1B), the server 170 (refer to FIG. 1B), the wireless device 200 (refer to FIG. 2), and/or the like. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. In addition, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and Blu-Ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A method for determining a height at which a communication device having an electronic processor and a sensor is located, the method comprising:
obtaining a reference height of a first location, the reference height being a known height relative to ground level, the reference height having a corresponding reference pressure;
obtaining, with the sensor, a pressure measurement at a second location; and
calculating, with the electronic processor, a height at the second location based on the pressure measurement, the reference height, and the reference pressure.

2. The method of claim 1, the method further comprising:
obtaining, with a sensor, an associated temperature measurement at one or more of the first location and the second location;
wherein calculating, with an electronic processor, a height comprises: calculating, with an electronic processor, a height at the second location based on the pressure measurement, the temperature measurement, and at least one of the reference height and the reference pressure.

3. The method of claim 1, the method further comprising:
obtaining associated longitude and latitude coordinates for the first location; and
retrieving the reference height at the first location from a database, remote from the communication device, based on the longitude and latitude coordinates.

4. The method of claim 3, wherein obtaining comprises: obtaining, via a satellite positioning system, associated longitude and latitude coordinates for the first location.

5. The method of claim 3, wherein obtaining comprises: obtaining, via a terrestrial positioning system, associated longitude and latitude coordinates for the first location.

6. The method of claim 1, the method further comprising:
determining a location of the communication device when at the first location;
comparing the location of the communication device to a set of pre-known locations each having pre-known heights; and
obtaining the reference height by retrieving a pre-known height of a pre-known location that matches the location of the communication device.

7. The method of claim 6, wherein the pre-known height is stored in a memory of the communication device as the reference height.

8. The method of claim 6, wherein one of the pre-known locations corresponds to a location of a charging station for charging the communication device.

9. The method of claim 8, wherein a height of the charging station is stored in a memory of the communication device as the reference height.

10. The method of claim 6, wherein one of the pre-known locations corresponds to a location of a computing device for synchronizing with the communication device.

11. The method of claim 10, wherein a height of the computing device is stored in a memory of the communication device as the reference height.

12. The method of claim 1, the method further comprising:
obtaining the reference height, comprising:
determining an instantaneous velocity of the communication device;
comparing the instantaneous velocity with a specified threshold; and
storing, in a memory of the communication device, a ground level height as the reference height, if the instantaneous velocity is greater than the specified threshold.

13. The method of claim 1, the method further comprising:
determining whether a pressure change between the reference height and the pressure measurement was due to a height change.

14. The method of claim 1, the method further comprising:
revising data used to determine the reference height if a pressure change between the pressure of the reference height and the measured pressure is less than a specified threshold.

15. The method of claim 1, the method further comprising:
revising data used to determine the height if a pressure change between the pressure of the reference height and the measured pressure is greater than a specified threshold.

16. The method of claim 1, the method further comprising:
obtaining, via a satellite positioning system, associated longitude and latitude coordinates for one or more of the first location and the second location;
wherein calculating, with an electronic processor, a height comprises: calculating, with an electronic processor, a height at the second location based on the pressure measurement, the longitude and latitude coordinates, and at least one of the reference height and the reference pressure.

17. The method of claim 1, the method further comprising:
obtaining, via a satellite positioning system, a z coordinate estimate of the height of the second location;
wherein calculating, with an electronic processor, a height comprises: calculating, with an electronic processor, a height at the second location based on the pressure measurement, the z-coordinate estimate, and at least one of the reference height and the reference pressure.

18. The method of claim 1, the method further comprising:
obtaining, via a terrestrial positioning system, associated longitude and latitude coordinates for one or more of the first location and the second location;
wherein calculating, with an electronic processor, a height comprises: calculating, with an electronic processor, a height at the second location based on the pressure measurement, the longitude and latitude coordinates, and at least one of the reference height and the reference pressure.

19. The method of claim 1, the method further comprising:
obtaining, via a terrestrial positioning system, a z coordinate estimate of the height of the second location;
wherein calculating, with an electronic processor, a height comprises: calculating, with an electronic processor, a height at the second location based on the pressure measurement, the z-coordinate estimate, and at least one of the reference height and the reference pressure.

20. The method of claim 1, the method further comprising:
obtaining, with the sensor, the reference pressure.

21. The method of claim 1, the method further comprising:
retrieving, from a remote location, the reference pressure.

22. The method of claim 1, wherein the first location and the second location differ in at least one of longitude, latitude, and height.

23. The method of claim 1, wherein the height is elevation above ground level.

24. The method of claim 1, the method further comprising:
storing, in a memory, the determined height as a new reference height.

25. A computer program product for determining a height at which a communication device having an electronic processor and a sensor is located, comprising:
a non-transitory computer-readable medium comprising code for:
obtaining a reference height of a first location, the reference height being a known height relative to ground level, the reference height having a corresponding reference pressure;
obtaining, with the sensor, a pressure measurement at a second location; and
calculating, with the electronic processor, a height at the second location based on the pressure measurement, the reference height, and the reference pressure.

26. An apparatus operable in a wireless communication system, the apparatus for determining a height at which the apparatus is located, the apparatus comprising:
a sensor;
a processor; and
a memory comprising processor executable code and/or data, the processor executable code, when executed by the processor, configures the device to:
obtain a reference height of a first location, the reference height being a known height relative to ground level, the reference height having a corresponding reference pressure;
obtain, with the sensor, a pressure measurement at a second location; and
calculate, with the processor, a height at the second location based on the pressure measurement, the reference height, and the reference pressure.

27. An apparatus for determining a height at which a communication device having an electronic processor and a sensor is located, the apparatus comprising:
means for obtaining a reference height of a first location, the reference height being a known height relative to ground level, the reference height having a corresponding reference pressure;
means for obtaining, with the sensor, a pressure measurement at a second location; and
calculating, with the electronic processor, a height at the second location based on the pressure measurement, the reference height, and the reference pressure.

28. A method for determining a height at which a communication device having an electronic processor and a sensor is located, the method comprising:
obtaining location data for a location of the communication device;
obtaining, with the sensor, a pressure measurement at the location of the communication device;
obtaining elevation data for the location of the communication device based on the location data; and
calculating a height of the communication device at the location based at least on the pressure measurement and the elevation data.

29. The method of claim 28, the method further comprising:
obtaining, from a weather database, a reference sea level pressure for the location of the communication device based on the location data;
wherein calculating a height comprises: calculating a height of the communication device at the location based at least on the pressure measurement, the elevation data, and the reference sea level pressure.

30. The method of claim 28, wherein the location data of the communication device comprises latitude and longitude coordinates of the communication device.

31. The method of claim 28, wherein the communication device is configured to obtain the location data, obtain the elevation data, and calculate the height.

32. The method of claim 28, wherein a server remote from the communication device is configured to obtain the location data from the communication device, the pressure measurement from the communication device, obtain the elevation data, and calculate the height.

33. The method of claim 32, the method further comprising:
storing the calculated height in a memory of the communication device.

34. The method of claim 28, the method further comprising:
obtaining, with a sensor, a temperature at the location of the communication device;
wherein calculating a height comprises: calculating a height of the communication device at the location based at least on the pressure measurement, the elevation data, and the temperature.

35. The method of claim 28, wherein obtaining location data comprises: obtaining, via a satellite positioning system, location data for a location of the communication device.

36. The method of claim 28, wherein obtaining location data comprises: obtaining, via a terrestrial positioning system, location data for a location of the communication device.

37. The method of claim 28, the method further comprising:
storing the calculated height in a memory of the communication device.

38. A computer program product for determining a height at which a communication device having an electronic processor and a sensor is located, comprising:
a non-transitory computer-readable medium comprising code for:
obtaining location data for a location of the communication device;
obtaining, with the sensor, a pressure measurement at the location of the communication device;
obtaining elevation data for the location of the communication device based on the location data; and
calculating a height of the communication device at the location based at least on the pressure measurement and the elevation data.

39. An apparatus operable in a wireless communication system, the apparatus for determining a height at which the apparatus is located, the apparatus comprising:
a sensor;
a processor; and
a memory comprising processor executable code and/or data, the processor executable code, when executed by the processor, configures the device to:
obtain location data for a location of the communication device;
obtain, with the sensor, a pressure measurement at the location of the communication device;
obtain elevation data for the location of the communication device based on the location data; and
calculate a height of the communication device at the location based at least on the pressure measurement and the elevation data.

40. An apparatus for determining a height at which a communication device having an electronic processor and a sensor is located, the apparatus comprising:
means for obtaining location data for a location of the communication device;
means for obtaining, with the sensor, a pressure measurement at the location of the communication device;
means for obtaining elevation data for the location of the communication device based on the location data; and
means for calculating a height of the communication device at the location based at least on the pressure measurement and the elevation data.
